(19) United States
(12) Patent Application Publication
(10) Pub. No.: US 2023/0295976 A1
(43) Pub. Date: Sep. 21, 2023

(54) LIFT GATES AND RELATED CONTROL SYSTEMS AND METHODS

(71) Applicant: Leonard Automatics, Inc., Denver, NC (US)

(72) Inventors: Jeffrey N. Frushtick, Mooresville, NC (US); Bradley D. Hamrick, Shelby, NC (US)

(21) Appl. No.: 18/185,157

(22) Filed: Mar. 16, 2023

Related U.S. Application Data
(60) Provisional application No. 63/337,699, filed on May 3, 2022.
(60) Provisional application No. 63/320,286, filed on Mar. 16, 2022.

(51) Int. Cl. E05F 15/673; E06B 3/50

(52) U.S. Cl. CPC E05F 15/673; E06B 3/5018; E06B 3/5081; E05Y 2400/332; E05Y 2400/354; E05Y 2900/40

(57) ABSTRACT

A gate system and related control systems and methods include a frame assembly and a tracking assembly coupled to the frame assembly. A door is in mechanical communication with the frame assembly. Related methods for operating a gate of a gate system, where the gate is set to manual mode to manually open or close the gate. Additionally, control systems include a fail-safe programmable logic controller (PLC) circuit for controlling the gate for opening and closing a gate that employs redundant fail-safe features. The control system includes a safety PLC circuit having a PLC including a first input terminal and a second input terminal, and a light curtain switch electrically coupled to the first and second input terminals.

### CROSS-REFERENCE TO RELATED APPLICATIONS

This application claims priority benefit of U.S. Provisional Pat. Application No. 63/320,286 filed on Mar. 16, 2022 entitled Lift Gate, and claims priority benefit of U.S. Provisional Pat. Application No. 63/337,699 filed May 03, 2022 entitled Lift Gate Control System, the entire contents of each of the above applications are hereby expressly incorporated herein by reference.

### TECHNICAL FIELD

One or more aspects of the present disclosure broadly relates to lift gates and related control systems, and more particularly to a gate systems and related control systems that lift or tilt open that are configured for commercial garage complex gate systems and employ redundant fail-safe features.

### BACKGROUND

As commonly known, gates that tilt or lift are often installed at entrances and/or exists of commercial parking garages or at other similar locations in order to allow for selected entry/exit of vehicles at a location. For instance, gates may be positioned at entrances and/or exits of storage facilities, warehouses, parking garages, secure facilities, or other locations in order to regulate or control access to a certain area. In many instances, lift gates include a flat or planar door that tilts as they are lifted upwards to rest flat overhead in the direction of, at, or near a ceiling. The typical lifting system includes an overhead operator with a motor that drives an arm for lifting the gate. These types of gate systems are typically employed in mixed use residential or in high-density residential developments with secure private parking located within the complex grounds, or in commercial buildings with secure parking. The gate systems may be useful where space is minimal and/or the door is required to weigh more and/or be more rigid than a single family, residential garage door. In this instance, the gate may weigh much more than a residential garage door or horizontally aligned multi-panel doors; thus, the operator and hardware are built much heavier to accommodate these heavier loads.

However, it has become increasingly important to develop dependable gate systems to accommodate many different spaces, especially smaller sized spaces. Additionally, it is desired for the manufacturing and/or retrofitting, assembly, and maintenance of such gate systems to become increasingly more time efficient, ergonomic, and cost efficient. As such, the components of the gate systems may be required to be simplified while also still maintaining the force, rigidity, and power to easily lift the lift gates.

In certain lift gate systems, it may be desired to have the door have additional capabilities of opening in an emergency situation or in situations where a lift mechanism is inoperable, such as may happen with a loss of power.

Therefore, there remains a need for an improved lift gate system that solves these problems.

### SUMMARY

The following discussion discloses and describes an improved lift gate system, and also discloses a related control system for opening and closing a gate that employs redundant fail-safe features. The control system includes a Safety PLC circuit having a safety PLC including a first input terminal and a second input terminal. The Safety PLC circuit also includes a light curtain switch electrically coupled to the first and second input terminals, where the light curtain switch is responsive to a signal from an optical light curtain device that identifies an object in a light curtain to stop movement of the gate, a bump strip switch electrically coupled to the first and second input terminals, where the bump strip switch is responsive to a signal from a bump strip on the gate that indicates that the gate has hit an object to stop movement of the gate, and a laser camera switch electrically coupled to the first and second input terminals, where the laser camera switch is responsive to a signal from a laser camera that indicates that an object is in a travel area of the gate to stop movement of the gate. There are also induction loops cut into the concrete to detect presence of a large metal structure such as a car or truck, one or two on the entrance and one on the exit side of the gate. These detect the presence of the car at the gate to allow the gate to be opened with an input device such as a keypad, key fob or remote. The second loop at the exit verifies that the vehicle has cleared the area to allow the gate to close safely. There may also be a laser to verify the vehicle instead of induction loops. There are many other devices that can “see” the vehicle in the critical zone for operation.

Additional features of the disclosure will become apparent from the following description and appended claims, taken in conjunction with the accompanying drawings.

### BRIEF DESCRIPTION OF THE DRAWINGS

One or more aspects of the invention are particularly pointed out and distinctly claimed as examples in the claims at the conclusion of the specification. The foregoing and other objects, features, and advantages of one or more aspects are apparent from the following detailed description taken in conjunction with the accompanying drawings in which:

FIG. 1 is a front perspective view of a gate assembly of a gate system according to an embodiment of the disclosure;

FIG. 2 is a rear perspective view of the gate assembly of FIG. 1 according to an embodiment of the disclosure;

FIG. 3 is a bottom perspective view of the gate assembly of FIGS. 1-2 according to an embodiment of the disclosure;

FIG. 4 is a front elevational view of the gate assembly of FIGS. 1-3 according to an embodiment of the disclosure;

FIG. 5 is a rear elevational view of the gate assembly of FIGS. 1-4 according to an embodiment of the disclosure;

FIG. 6 is a fragmentary front elevational view of the gate assembly of FIGS. 1-5, wherein portions of a side post of the gate assembly are removed to show internal components of the side post according to an embodiment of the disclosure;

FIG. 7 is a left side elevational view of the gate assembly of FIGS. 1-6, wherein portions of the side post and upper track assembly are removed to show internal components thereof according to an embodiment of the disclosure;

FIG. 8 is a fragmentary top perspective view of the gate assembly of FIGS. 1-7, wherein one of a pair of door panels is shown in an outwardly open position according to an embodiment of the disclosure;

FIG. 9 is a front perspective view of the gate assembly of FIGS. 1-8; wherein the one of the pair of door panels is shown in the outwardly open position according to an embodiment of the disclosure;

FIG. 10 is a front perspective view of the gate assembly of FIGS. 1-9, wherein the pair of door panels are shown in an inwardly open position according to an embodiment of the disclosure;

FIG. 11 is a rear perspective view of the gate assembly of FIGS. 1-10, wherein the pair of door panels are shown in the inwardly open position according to an embodiment of the disclosure;

FIG. 12 is a partially exploded front perspective view of the gate assembly of FIGS. 1-11 according to an embodiment of the disclosure;

FIG. 13 is an enlarged fragmentary partially exploded front perspective view of the gate assembly of FIGS. 1-12 according to an embodiment of the disclosure;

FIG. 14 is a front perspective view of the gate assembly of FIGS. 1-13 according to an embodiment of the disclosure;

FIG. 15A is a fragmentary top rear perspective view of the gate assembly of FIGS. 1-14, wherein the pair of door panels are schematically illustrated as tilting towards an upwardly open position according to an embodiment of the disclosure;

FIG. 15B is a front perspective view of the gate assembly of FIGS. 1-14, wherein the pair of door panels are schematically illustrated as tilting towards an upwardly open position according to an embodiment of the disclosure;

FIG. 16 is a front perspective view of the gate assembly of FIGS. 1-15, wherein the door panels are shown as progressively, as compared to FIGS. 15A-15B, tilting towards the upwardly open position according to an embodiment of the disclosure;

FIG. 17 is a front perspective view of a gate system that includes a human machine interface according to an embodiment of the present disclosure;

FIG. 18 is a rear perspective view of the gate system of FIG. 17 according to an embodiment of the present disclosure;

FIG. 19 is a front elevational view of the gate system of FIGS. 17-18 according to an embodiment of the present disclosure;

FIG. 20 is a rear elevational view of the gate system of FIGS. 17-19 according to an embodiment of the present disclosure;

FIG. 21 is a flow diagram showing a process for operating a gate in a manual mode according to an embodiment of the disclosure; and

FIG. 22 is a schematic diagram of an example gate circuit including a fail-safe programmable logic controller (PLC) for controlling a gate according to an embodiment of the disclosure;

FIG. 23A is a schematic diagram of another example gate circuit that includes a fail-safe PLC for controlling a gate according to an embodiment of the disclosure; and

FIG. 23B is an alternate view of the schematic diagram of the gate circuit of FIG. 23A, according to one embodiment.

### DETAILED DESCRIPTION OF THE EMBODIMENTS

The following detailed description and appended drawings describe and illustrate various exemplary embodiments of the disclosure. The description and drawings serve to enable one skilled in the art to make and use the disclosure, and are not intended to limit the scope of the disclosure in any manner. In respect of the methods disclosed, the steps presented are exemplary in nature, and thus, the order of the steps is not necessary or critical.

“A” and “an” as used herein indicate “at least one” of the item is present; a plurality of such items may be present, when possible. Spatially relative terms, such as “front,” “back,” “inner,” “outer,” “bottom,” “top,” “horizontal,” “vertical,” “upper,” “lower,” “side,” “above,” “below,” “beneath,” “upwardly,” “outwardly,” “inwardly,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures.

It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

As used herein, substantially is defined as “to a considerable degree” or “proximate” or as otherwise understood by one ordinarily skilled in the art or as otherwise noted. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

The terms “couple”, “coupled”, “couples”, “coupling”, “fixed”, “attached to”, “connect”, “connected”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

Where any conflict or ambiguity may exist between a document incorporated by reference and this detailed description, the present detailed description controls. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context.

The present technology relates to gates and gate systems commonly used as tilt or lift gates in residential and or commercial type garage settings.

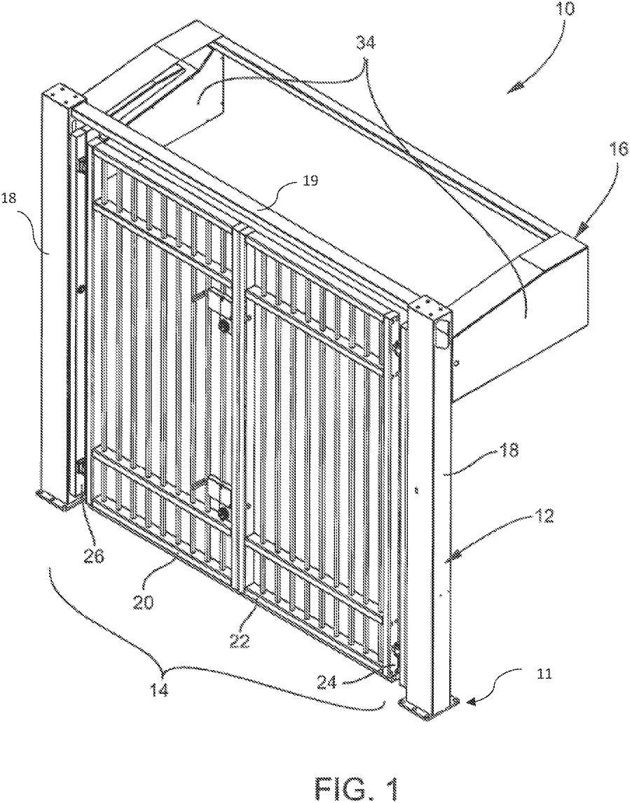

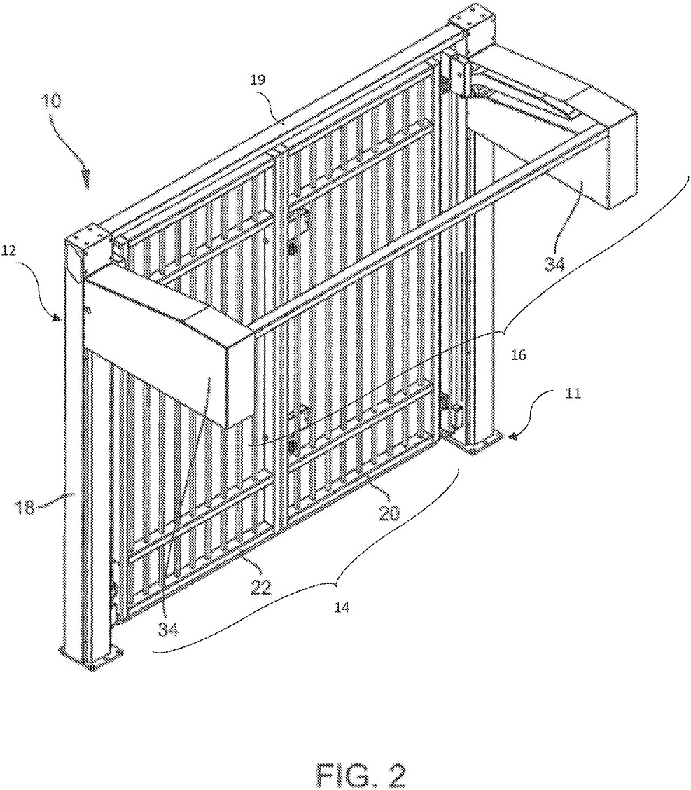

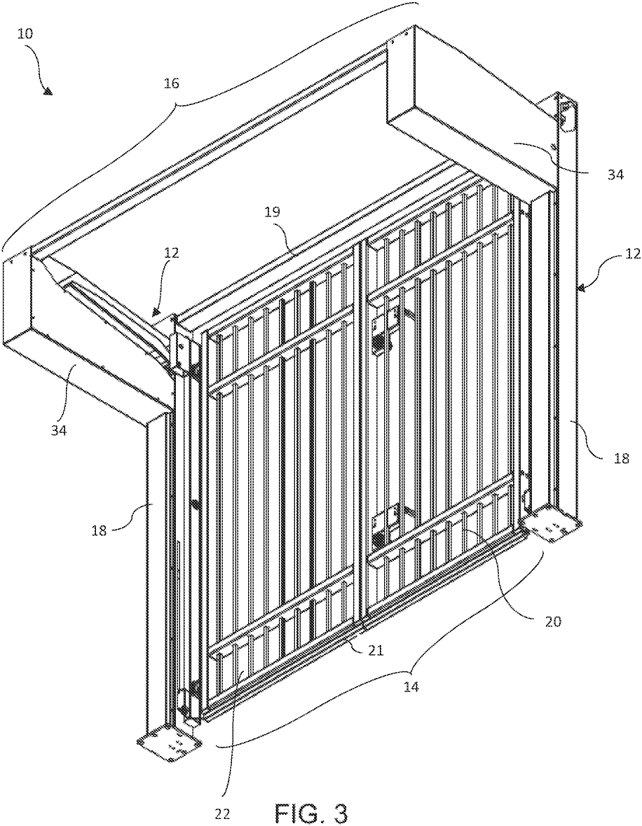

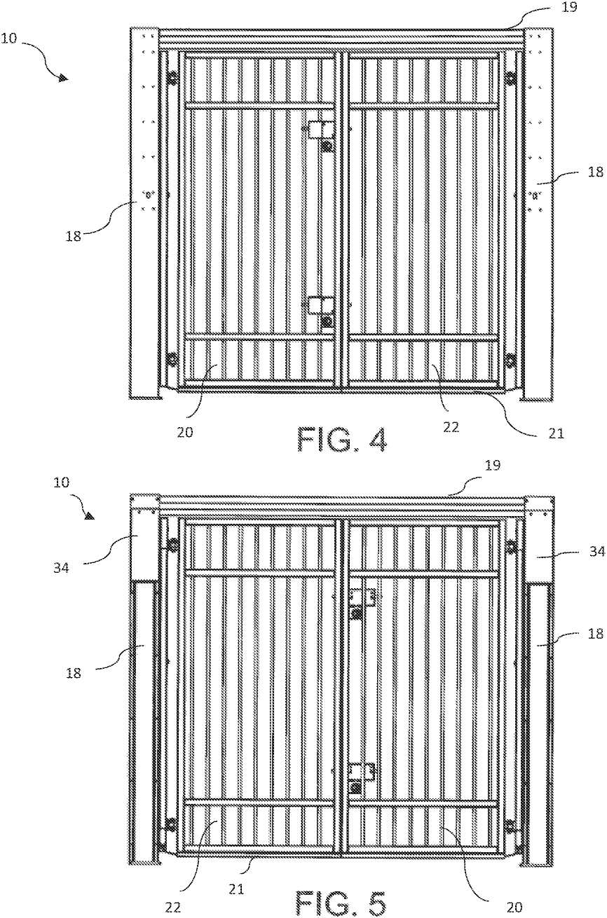

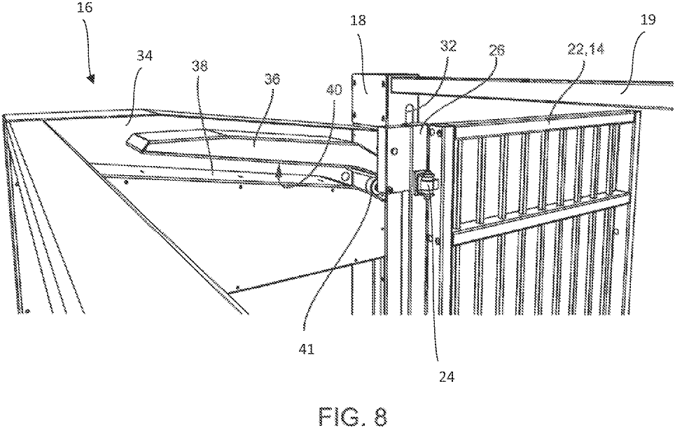

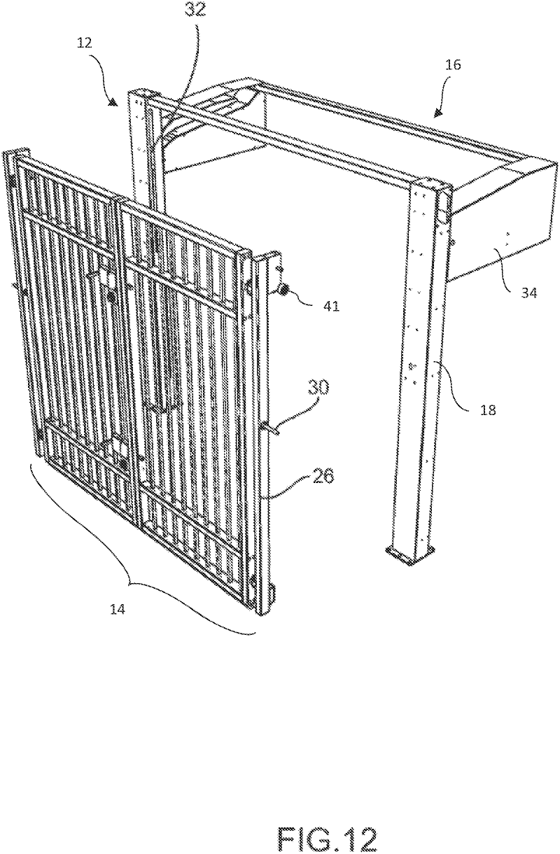

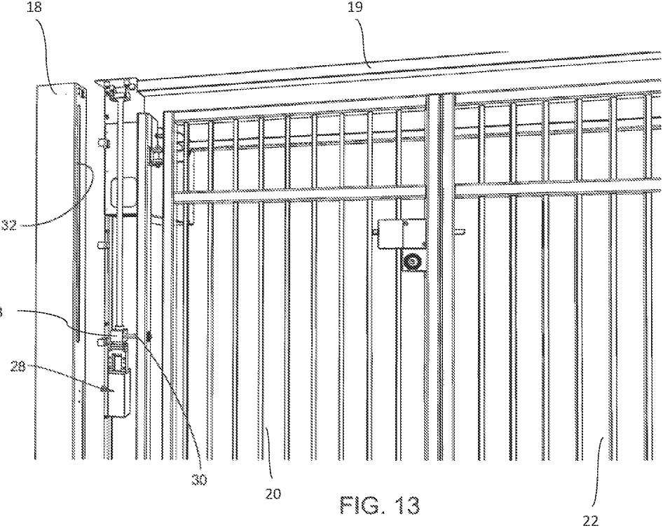

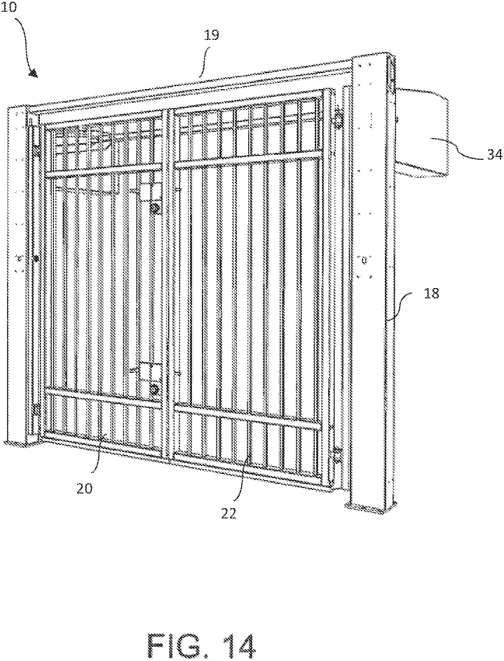

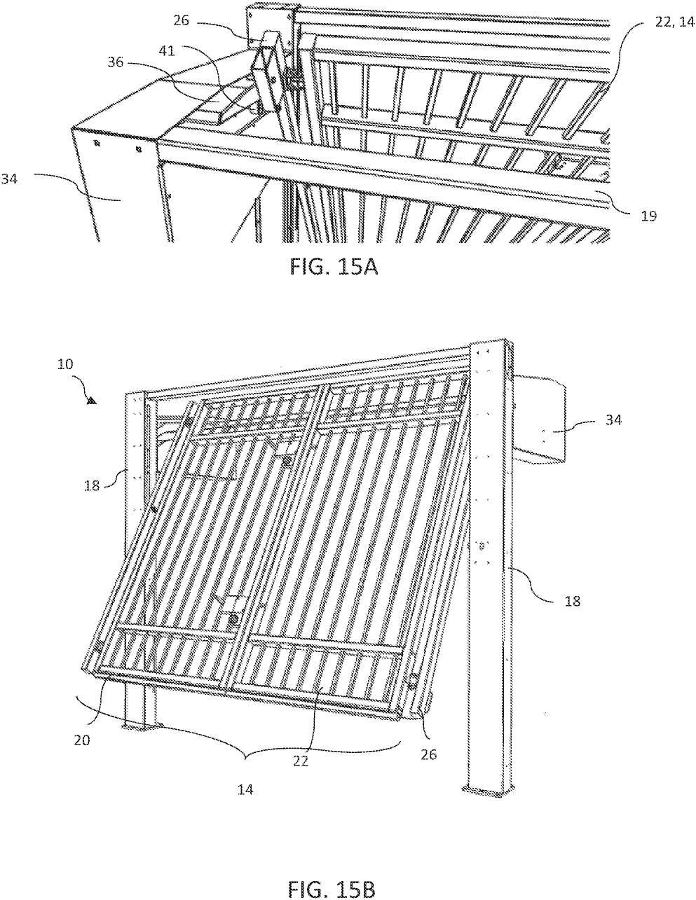

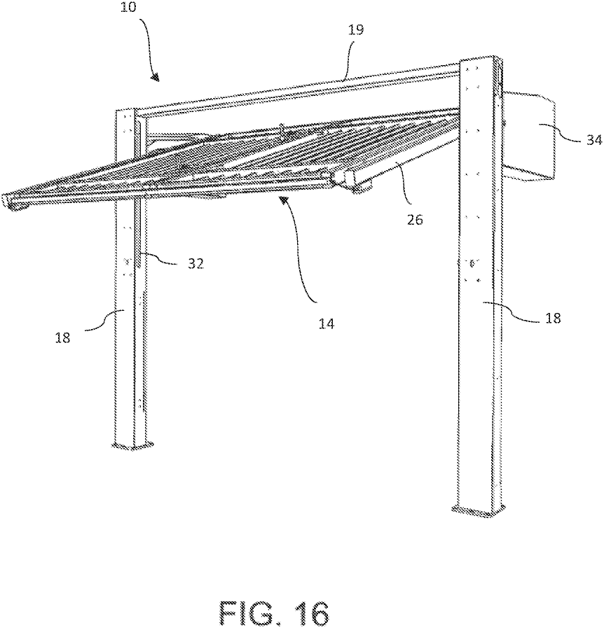

FIGS. 1-16 illustrate a gate assembly of a gate system 10 configured to permit entry or exit to a location (e.g., an enclosed area such as a garage or storage area). The gate system 10 includes a frame assembly 12, a door 14, and a track assembly 16. The frame assembly 12 supports and secures the track assembly 16 and the door 14, which is in mechanical communication with the track assembly 16.

The frame assembly 12 includes a pair of vertical posts 18 and an upper horizontal beam 19 disposed between the posts 18. It is understood the frame assembly 12 can include additional posts, beams and components if desired. The posts 18 are configured to be directly coupled (e.g., via screws, pins, hooks, etc.) to a substrate 11 (e.g., the ground, concrete, etc.). Although, according to various embodiments, the posts 18 can be indirectly coupled to the substrate 11, if desired. In one embodiment, the posts 18 are substantially rectangular in cross-section and define an interior receptacle for receiving other components, which will be described herein below. It is understood, however, that the posts can have other cross-sectional shapes (e.g., circle, square, hexagonal, triangular, etc.) as desired.

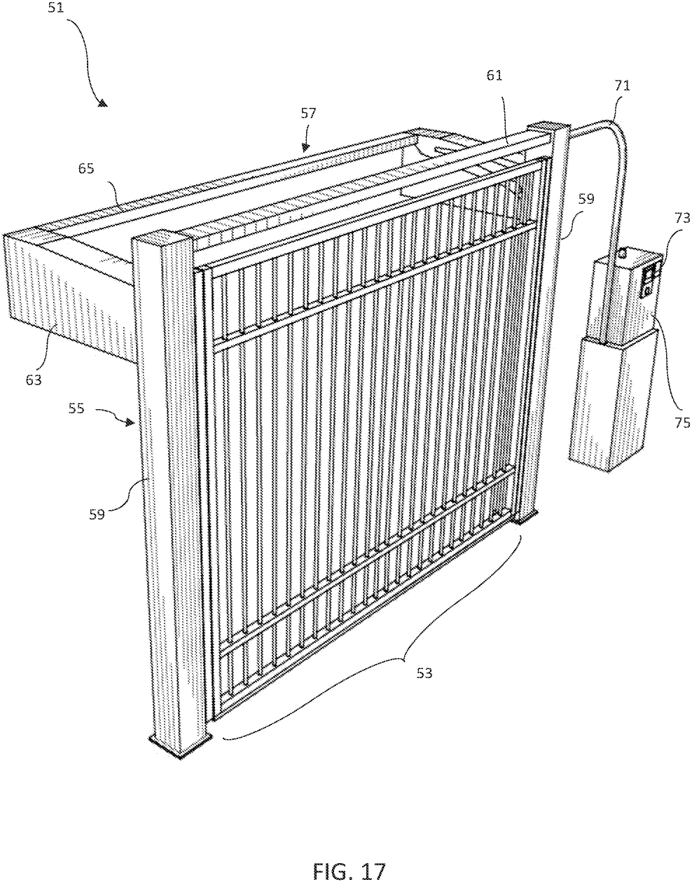

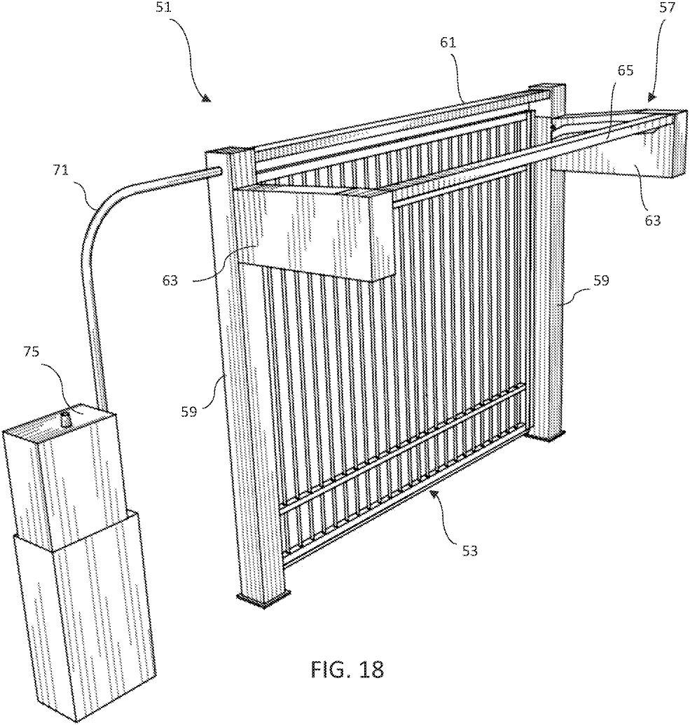

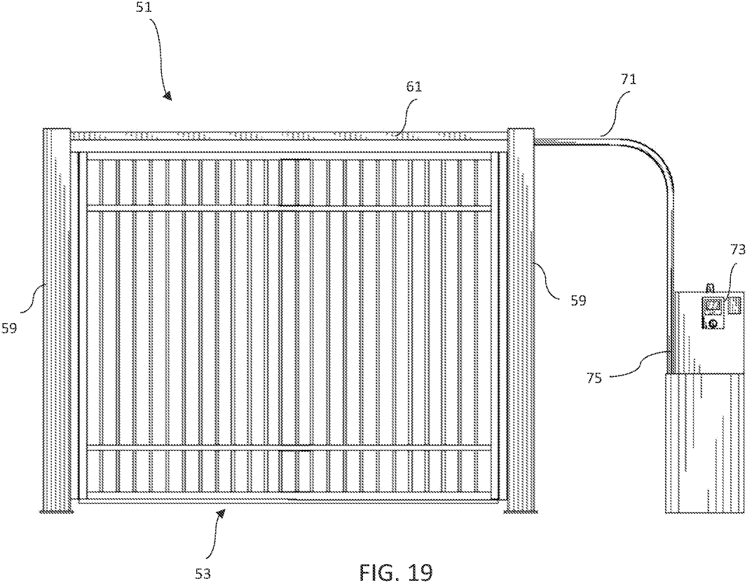

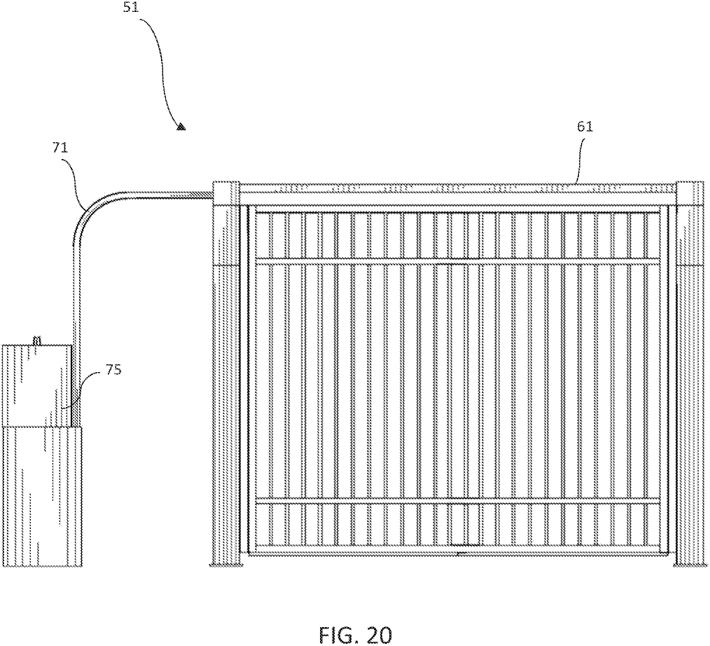

According to one embodiment, it is contemplated that the door 14 is a single, uninterrupted panel (see FIGS. 17-20). According to an alternate embodiment, the door 14 is substantially planar and may also include a first door panel 20 and a second door panel 22 (as depicted in FIGS. 1-16), where the first door panel 20 and the second door panel 22 are vertically divided and aligned. According to this alternate embodiment, as depicted in FIGS. 1-16, the door panels 20, 22 are each shown to include a plurality of vertically aligned bars disposed with intermediate vertically aligned spaces to permit one to see through the door. However, in other embodiments, not shown, the door panels 20, 22 can include solid, contain horizontal bars, and/or include a transparent substance such as glass or polymeric glass to allow one to see there through the door panels 20, 22. The door 14, whether a single uninterrupted panel or multi-paneled, includes a bottom edge 21 that, when the door 14 is not elevated is opposite the horizontal beam 19 proximate the substrate 11 (e.g., the ground, concrete, etc.).

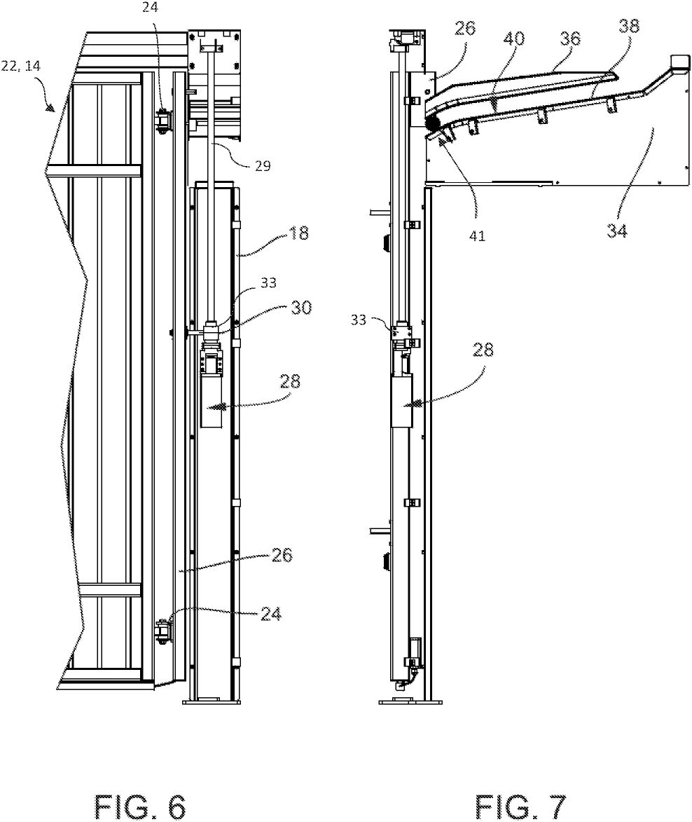

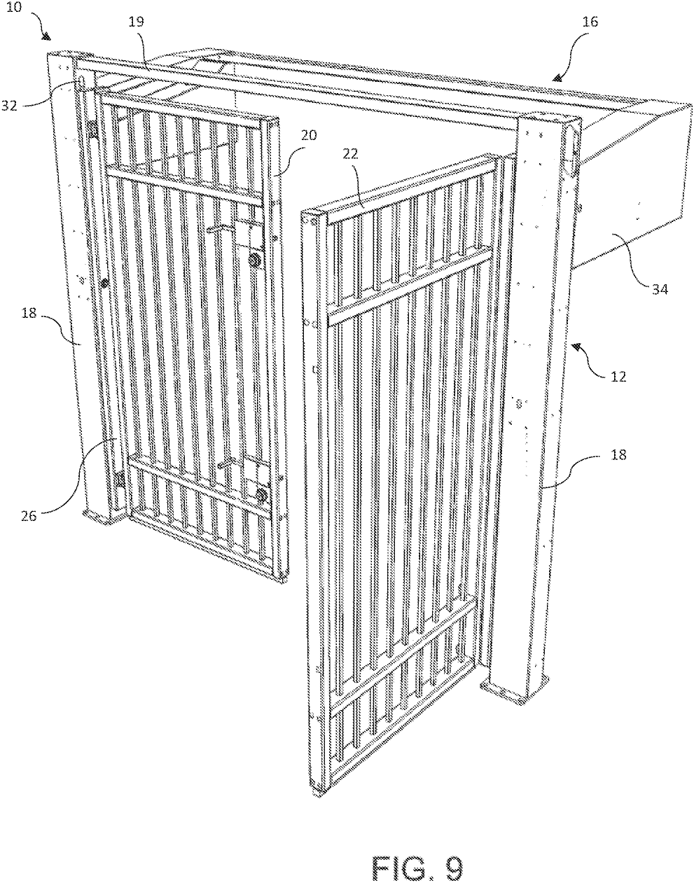

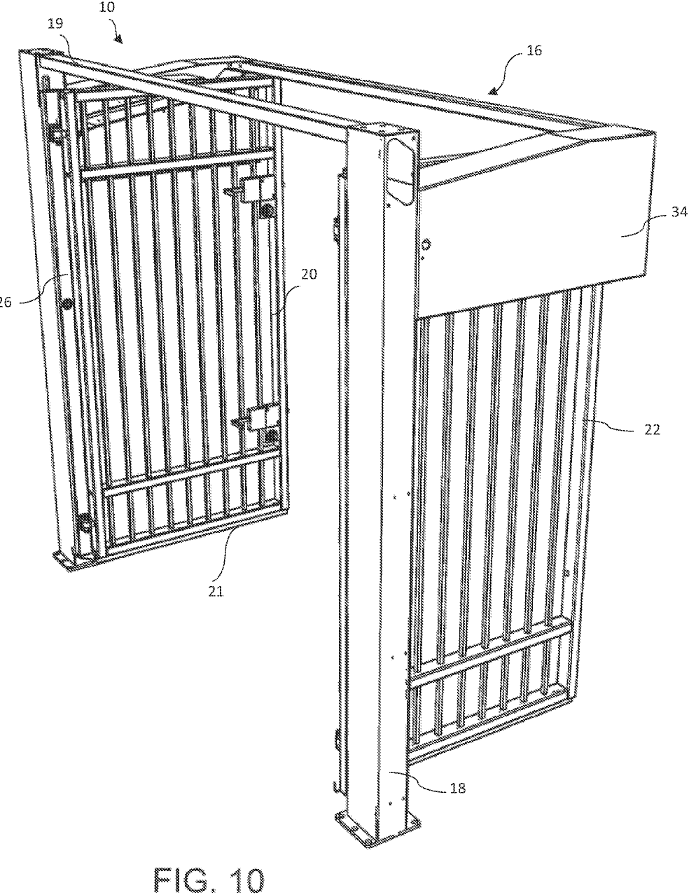

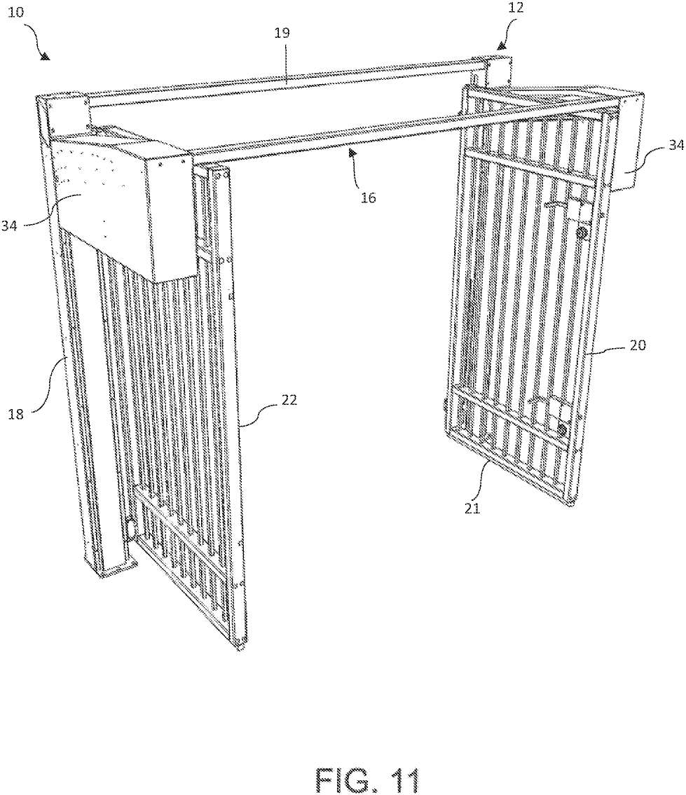

According to the alternate embodiment, at least one, or in some embodiments each, of the door panels 20, 22 includes a hinge assembly 24 (see FIG. 6) coupling a side (e.g. an outer edge) of each of the doors 20, 22 to a vertical member 26 such that each of the door panels 20, 22 can rotate with respect to a length of the vertical member 26. Each vertical member 26 may be configured to align lengthwise with a respective post 18 and may be coupled to an axle 30. As such, each of the door panels 20, 22 rotate with respect to a length of the posts 18 as well as the vertical member 26. The door panels 20, 22 each can rotate from a closed position (see FIGS. 1-5) to an outwardly open position (see FIG. 9) or an inwardly open position (see FIGS. 10-11).

Each of the posts 18 include an actuator 28 mounted within the interior receptacle thereof (e.g., within a hollow interior of the posts 18). The actuators 28 are configured as linear actuators such as screw ball linear actuators, which are beneficial in applications requiring heavy loads and continuous duty cycles. However, it is understood the actuators 28 can be any type of linear actuators of the pneumatic, electro-mechanical (e.g., leadscrew, rack and pinion, belt driven, and cam actuators, etc.), or piezoelectric varieties. Also contemplated herein, the actuators 28 could also include coiled, electromechanical, telescoping, and ball slide actuators.

The actuators 28 may also be hydraulic, according to various embodiments. However, hydraulic systems may require the addition of a hydraulic pump and additional tubing, which may add to the footprint of the systems. As contemplated, the present disclosure specifically includes an embodiment that excludes the use of a hydraulic actuator, which advantageously would eliminate the need that such a system would have for a hydraulic pump. Likewise, the embodiment of the present disclosure that excludes hydraulic actuation also excludes any and all hydraulic fluid, hydraulic pressure relief valves, multiple safety switches on each hydraulic cylinder, etc.

According to another aspect of the present disclosure, the gate system 10 is characterized by a lack of any balancing, biasing or assist springs, which may be prone to failure and may be commonly found in prior art designs.

As depicted, the actuators 28 are mounted linearly with respect to a length of the posts 18. In this particular example, a screw ball linear actuator 28 is depicted in which a ball screw rotates about a threaded shaft 29 of the actuator 28, and the rotary motion is converted to linear motion. A block 33 of each of the actuators 28 is coupled to a respective axle or pin 30 and attached to a respective threaded shaft 29 of the respective actuator 28. The threaded shaft 29 rotates about an axis having a continuous groove that runs helically along the length of the shaft. A cylinder houses ball bearings and also includes grooves that align with the helical groove of the threaded shaft 29. The ball bearings have few contact points with the helical groove of the threaded shaft 29 and the grooves of the cylinder due to the groove profile of the helical groove and the grooves of the cylinder. The groove profile may include, for example, a gothic arc profile or a semicircular arc profile. The block 33 is configured to move linearly to traverse the length of the actuator 28 when the actuator 28 is activated. The axle 30 extends through a linear slot 32 formed in a side of each of the posts 18, adjacent the respective door panel 20, 22. The axle 30 is coupled to the vertical member 26, thus coupling the vertical member 26 to the frame assembly 12. Because the door 14 is coupled, via the axle 30, to the actuators 28 within the frame assembly 12, the actuators 28 cause the door 14 to translate in a substantially vertical direction with respect to a length direction of the posts 18 along the slot 32 such that due to the door axle 30 being coupled to the block 33, movement of the block along the length of the actuator causes the door 14 to translate in a substantially vertical direction.

The track assembly 16 includes a pair of guard housings 34 each coupled to an upper portion of a respective one of the posts 18. The pair of guard housings 34 are configured for containing internal components, such as motors, pulleys, tracks, electrical components, etc. for operating the gate system 10. Each of the guard housings 34 includes a dog-legged shaped track arm 36 cooperating with a surface 38 of the guard housings 34 to form a dog-legged shaped guide rail 40 for receiving a track roller 41. The track roller 41 is coupled to an upper portion of the respective one of the vertical members 26. The guide rail 40 extends is an outward direction away from the posts 18 to a rear of the guard housings 34 in a slightly upwardly arcuate manner.

In operation, as the door 14 translates linearly with respect to a length direction of the posts 18, the track roller 40 simultaneously translates along the guide rail 40 to cause the door 14 to tilt or rotate with respect to a horizontal direction from the closed position to an upwardly open position (see FIGS. 15A - 16) such that the bottom edge 21 is elevated. Likewise, in embodiments with multiple door panels, each of the door panels 20, 22 can rotate from the closed position to the upwardly open position either simultaneously together so that the entire door 14 opens, so that each of the door panels 20, 22 can upwardly open independently from each other, or so only one of the door panels 20, 22 rotate independently with respect to the other from the closed position to the upwardly open position. A locking system can assist in the simultaneously opening of the door panels 20, 22 such that the door panels 20, 22 are semi-permanently coupled as a default and upwardly rotate simultaneously. Additionally, the locking system also permits the door 14 (i.e., the door panels 20, 22) to be locked when in the closed position unless one has a key or keyless mechanism (e.g., key fob) in signal communication with the gate system to open one or both of the door panels 20, 22. In one example embodiment, the locking system may include a housing that includes a rod attached to one door panel and a corresponding aperture that is sized and shaped or otherwise configured to receive the rod located on the other door panel such that the rod may be slid into the corresponding aperture to lock the locking system and then released to unlock the locking system. Various other locking systems (e.g., padlock, deadbolts, lever handle, cam locks, knob locks, mortise locks, keypad locks, smart locks, magnetic/electromagnetic locks, etc.) are also contemplated herein.

FIGS. 17-20 depict a gate system 51 that includes a human machine interface 73, according to one embodiment. The gate system 51 includes a frame assembly 55, a door 53, and a track assembly 57 similar to those described above with reference to FIGS. 1-16. As depicted, in various embodiments the door 53 may include a single, uninterrupted panel. The frame assembly 55 may include a pair of vertical posts 59 and an upper horizontal beam 61 disposed between the posts 59. The track assembly 57 includes a pair of guard housings 63 each coupled to an upper portion of a respective one of the posts 59 and optionally includes a stabilizing beam 65 coupled to an upper rear section of the guard housings 63. The gate system 51 also includes a cable housing 71 housing one or more cables connecting a human machine interface 73 and/or a gate circuit (such as the gate circuit 90 of FIG. 22) to an actuator (such as actuator 28 of FIGS. 1-16). The cable housing 71 may be connected to a control housing 75 that houses a gate circuit (such as the gate circuit 90 of FIG. 22) and the human machine interface 73.

In some embodiments, rather than storing the gate circuit in the control housing 75, the controls such as those depicted in gate circuit 90 of FIG. 22 may be housed within either one of the guard housings 34 and the control housing 75 and cable housing 71 may be eliminated. Additionally, in one embodiment, the human machine interface 73 may also be stored in or mounted to either one of the guard housings 34. In another embodiment, the human machine interface 73 may be mounted at a remote location external to the gate system 10 and may be in wireless communication with the gate circuit 90. The controls may be controlled wirelessly via, for example, a wireless transmitter.

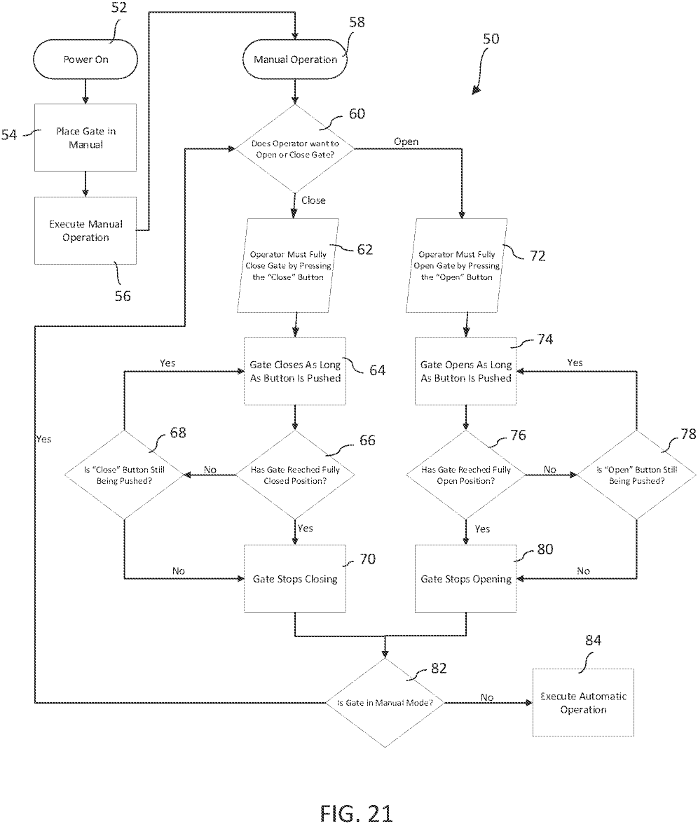

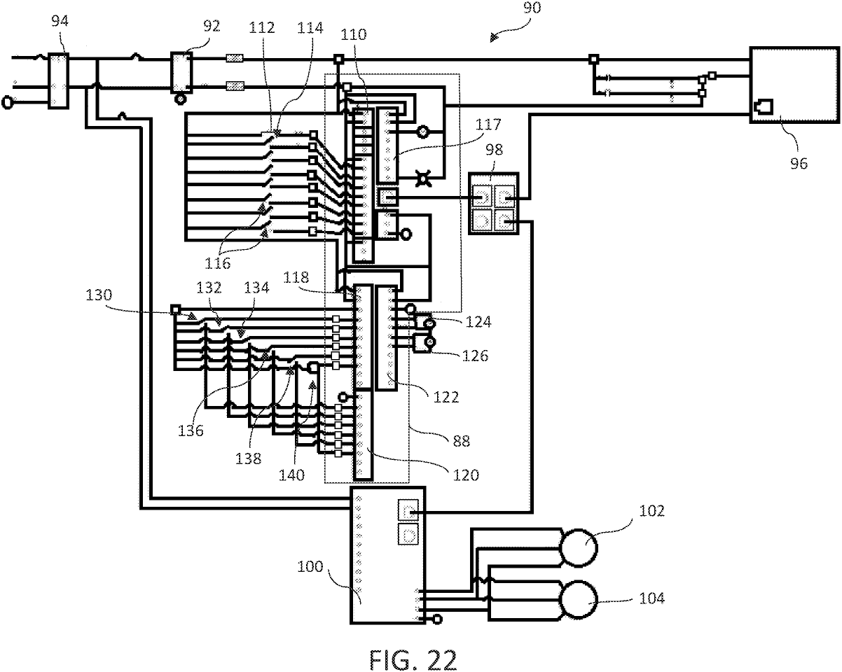

FIG. 21 is a flow diagram 50 showing a process for operating a gate in a manual mode, such as the gate system 10. However, the gate can be any lift gate system as desired. Additionally, the process can be employed with other systems not described herein or not relating to lift gates. A gate controller is powered on at box 52 and the gate control is placed in a manual mode at box 54. A manual gate operation algorithm is executed at box 56 and the manual operation begins at box 58. The algorithm determines whether the operator wants to open or close the gate at decision diamond 60. For closing the gate, a gate close button on the controller must be pressed for the gate to move from an open or partially open position to a closed position at box 62, where if the gate close button is being pressed, then the controller closes the gate at box 64. At predetermined sample times, the algorithm determines whether the gate has reached a fully closed position at decision diamond 66, and if not, the algorithm determines whether the gate close button is still being pressed at decision diamond 68, and if so, returns to the box 64 to continue closing the gate. If the gate is fully closed at the decision diamond 66 known by, for example, tripping a limit switch or the gate close button is not being pressed at the decision diamond 68, then the controller stops closing the gate at box 70.

For opening the gate, a gate open input, can be from a key fob button, key pad entry, micro chip RFID transponder, or other input device button must be pressed for the gate to move from a closed or partially open position to an open position at box 72, where if the gate open signal is being transmitted to the PLC controller, button is being pressed, then the controller opens the gate at box 74. At predetermined sample times, the algorithm determines whether the gate has reached a fully open position at decision diamond 76, and if not, the algorithm determines whether the gate open button is still being pressed at decision diamond 78, and if so, returns to the box 74 to continue opening the gate. If the gate is fully open at the decision diamond 76 known by, for example, tripping a limit switch or the gate open button is not being pressed at the decision diamond 78, then the controller stops opening the gate at box 80. When the gate stops closing at the box 70 or the gate stops opening at the box 80, the algorithm determines if the gate is still in the manual mode at decision diamond 82 and, if not, switches to the automatic mode at box 84. If the gate is still in the manual mode at the decision diamond 82, then the gate returns to manual operation at the box 58.

FIG. 22 is a schematic diagram of an example gate circuit 90 that includes a fail-safe PLC 88 for controlling a gate, for example, the gate system 10. The circuit 90 includes a 24 V direct current (DC) power source 92, such as a battery, and a battery backup circuit 94 that receives alternating (AC) power and charges the power source 92. A human-machine interface (HMI) 96 allows a user to control the PLC 88 for opening and closing the gate in a manual mode as discussed above with reference to the flow diagram 50, programming the speed that the gate moves, etc., and provides maintenance prompts, troubleshooting prompts, etc. An Ethernet module 98 provides an Ethernet connection to the PLC 88 so messages can be sent over the internet to and from the HMI 96. The circuit 90 also includes sigma-7 drive module 100 that controls rotary servo-motors 102 and 104 for opening and closing the gate. The motors 102, 104 may include, for example, a synchronous motor connected to the controls via various connection cables.

The PLC 88 includes an input terminal 110 that receives a number of input signals that operate a number of switches in the circuit 90. These switches include a manual switch 112 for putting the PLC 88 in the manual mode or the automatic mode, a floor loop detection switch 114 that closes when a floor loop detector (not shown) detects metal, such as from a car, for opening the gate, and a number of optional sensor switches 116 that provide system redundancy, and may receive signals from optical devices (not shown) to detect, for example, if a car is too close to the gate, a car tailgates another car through the gate, etc. These input signals cause the PLC 88 to perform some operation by providing output signals at an output terminal 117, such as opening or closing the gate. The capability is also there for photographic images of cars tailgating, colliding and damaging the gate or other events to be sent to the management company responsible for the location as well as to the gate manufacturer and or distributor.

The PLC 88 also includes redundant fail-safe input terminals 118 and 120 that each receive a number of fail-safe input signals for redundancy purposes that operate various two-position switches and may cause the PLC 88 to perform a safety function in response thereto through outputs in an output terminal 122, which may operate a close motor 124 or an open motor 126 to stop the movement of the gate. Those switches include a light curtain switch 130 that closes if an object is detected in a light curtain from an optical light curtain device (not shown) to stop movement of the gate. The light curtain switch 130 may be in communication with an optical light curtain device that is configured to detect an object in a light curtain. The light curtain device includes self-monitoring circuitry, a transmitter, and a receiver. The light curtain is formed when one or more light emitting components (e.g., a light emitting diode) of the transmitter of the light curtain device send a plurality of light pulses to the receiver according to a frequency pattern. Based on detecting the object disrupt the pattern of the light pulses received by the receiver, a signal is triggered to close the light curtain switch, thereby stopping movement of the gate. In particular, the light curtain switch is configured to be responsive to the signal received from the optical light curtain device, and upon receipt of that signal the light curtain switch transmits a stop signal to the PLC 88 to stop movement of the gate. According to one embodiment, the stop signal may be a wireless signal that is transmitted to the PLC 88. Upon receipt of the stop signal, the PLC 88 sends an output to the motor (e.g., close motor 124) thereby stopping movement of the gate.

The switches may also include a bump strip switch 132 that closes if a bump strip (not shown), also known as a bump edge protection strip, on a bottom edge (such as bottom edge 21 in FIGS. 1-16) of the gate hits something to stop movement of the gate. In particular, when compressed, the bump strip provides a signal to the bump strip switch 132 to close, thereby triggering a stop signal to the PLC 88 to send an output to the motor (e.g., close motor 124) and stop movement of the gate. The switches may also include a laser camera switch 134 that closes if an object is detected by a laser scanner/camera (not shown) within the rotational travel area of the gate to stop movement of the gate. For instance, the laser may be configured to detect another car tailgating or following directly behind a first car. Additionally, according to various embodiments, various customized actions can be initiated including, for example, an alarm, a sound, an electronic alert sent to an electronic device, etc. In other instances, additional safety devices such as vehicle detectors (e.g., ground loops or photodetectors) can be used to determine if two cars are tailgating. In some embodiments, the PLC 88 may also include a sensor configured to detect whether an over-height vehicle is detected. The switches may also in include a down pressure switch 136, an up-pressure switch 138 and/or an emergency stop switch 140.

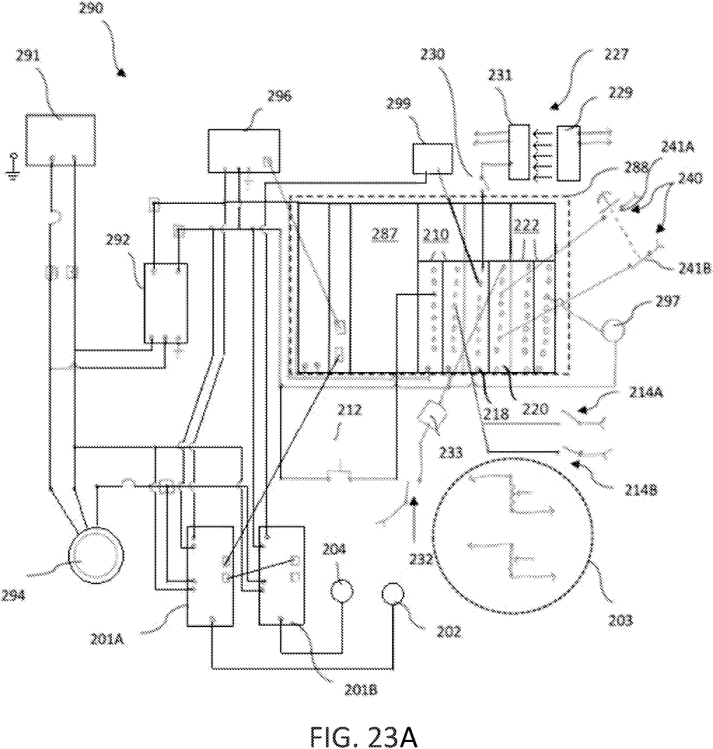

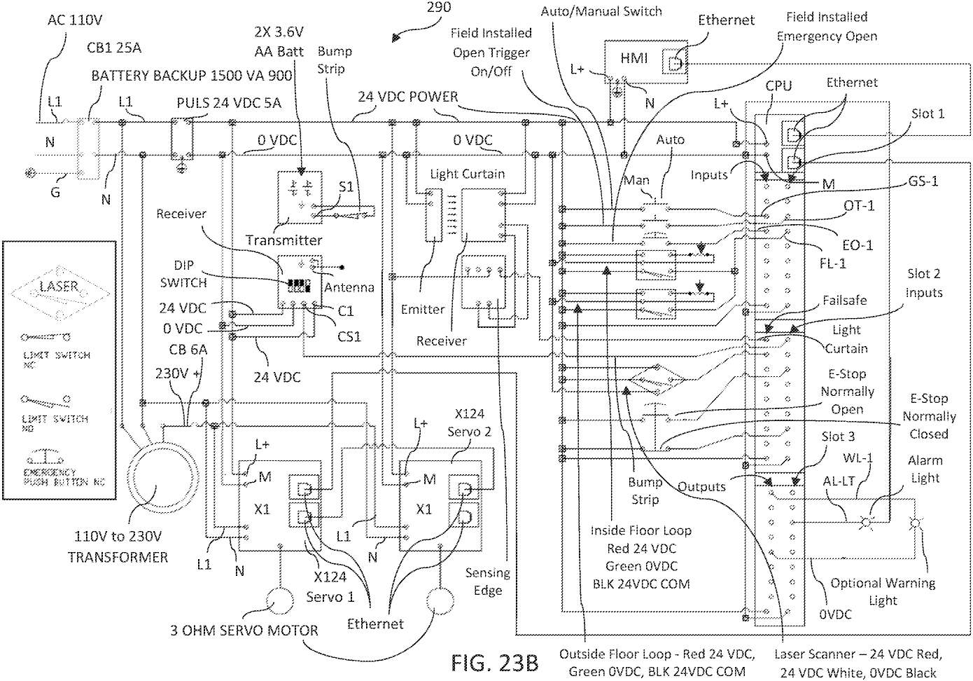

FIG. 23 is a schematic diagram of another example gate circuit 290 that includes a fail-safe PLC 288 for controlling a gate, for example the gate system 10, according to an embodiment of the disclosure. The circuit 290 includes a power supply 291, according to one embodiment, that may include an external power supply or may include an internal battery. The power supply 291 may provide AC power to an AC to DC converter 292 that outputs 24 V of direct current that is used to power a HMI 296 and the PLC 288. Additionally, the circuit 290 includes a transformer 294 (e.g., a toroidal transformer) configured to transfer incoming electrical energy at 110 V from the power supply 291 to amplify the signal and boost it to 230 V to power the servo drives 201A, 201B, which then cause the rotary servo motors 202, 204 to control the gate. The rotary servo motors 202, 204 may include synchronous motor(s). Additionally, the transformer 294 may act as a backup circuit to power the HMI 296 and the PLC 288. The HMI 296 allows a user to control the PLC to open and close the gate when in manual mode as discussed above, with reference to the flow diagram 50, program the speed the gate moves, and perform other functionalities.

The PLC 288 may include an input terminal 210 that is configured to receive various input signals that operate a number of switches in the circuit 290. Additionally, the PLC 288 includes a computer processing unit 287 configured to process the various input signals and direct various gate functionalities. The input terminal 210 is electrically connected to the manual switch 212 that can put the PLC 288 in manual mode or automatic mode. Additionally, the input terminal 210 is electrically connected to an inside floor loop detector 214A for detecting metal that is inside the gated area defined by the gate, and an outside floor loop 214B for detecting metal that is outside the gated area defined by the gate. The floor loops 214A and 214B may be connected in series, according to one embodiment.

The PLC 288 also includes redundant fail-safe input terminals 218, 220 that each receive a number of safety input signals for redundancy purposes. The fail-safe input terminals 218, 220 operate various two-position switches and may cause the PLC 288 to perform a safety function. An example two-position switch includes an emergency stop switch 240 that causes movement of the gate to stop. The emergency stop switch 240 may include a first position switch 241A that is normally open that, upon receiving an input signal, will close in the case of an emergency and a second position switch 241B that is normally closed and that, upon receiving an input signal, will open. In addition, the fail-safe input terminals 218, 220 are electrically coupled to a laser scanner 299 that is configured to detect object(s) and trigger the emergency stop switch 240 to stop movement of the gate. The fail-safe input terminals 218, 220 are also electrically coupled to a light curtain device 227 that includes an emitter 229 and a receiver 231 and a light curtain switch 230. The emitter 229 sends a plurality of light pulses to the receiver 231 according to a frequency pattern. Based on detecting an object that disrupts the pattern of the light pulses, the light curtain switch 230 closes, which then causes the emergency stop switch 240 to stop gate movement. The fail-safe input terminals 218, 220 are also electrically connected to a bump strip switch 232 that may pass through a gate receiver 233 prior to providing the input to the fail-safe input terminals 218, 220.

The PLC 288 also includes an output terminal 222 through which various output signals are transmitted. For instance, the output terminal 222 may be electrically connected to an alarm light 297 that activates when the emergency stop switch 240 is activated and the gate stops. In some embodiments, the output terminal 222 may also be electrically connected to an optional indicator light to provide an alert of a problem.

FIG. 23B is an alternate view of the schematic diagram of the gate circuit 290 of FIG. 23A, according to one embodiment.

Also depicted are example variable resistors 203 that may be used to adjust the voltage while keeping the current constant and may be connected to various other optional sensor switches (not shown).

In the flowchart illustrations and/or block diagrams disclosed herein, each block in the flowchart/diagrams may represent a module, segment, or portion of a method. In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

The corresponding structures, materials, acts, and equivalents of all means or step plus function elements in the claims below, if any, are intended to include any structure, material, or act for performing the function in combination with other claimed elements as specifically claimed. From the foregoing description, one ordinarily skilled in the art can easily ascertain the essential characteristics of this disclosure and, without departing from the spirit and scope thereof, can make various changes and modifications to the disclosure to adapt it to various usages and conditions.

What is claimed is:

1. A gate system, comprising:
a frame assembly;
a tracking assembly coupled to the frame assembly; and
a door in mechanical communication with the frame assembly via a pair of linear actuators and the tracking assembly via a guide rail engaging a track roller, the linear actuators and guide rail cooperating simultaneously with the door to rotate the door about an axis extending horizontally through the frame assembly.

2. The gate system of claim 1, wherein actuators are screw ball linear actuators.

3. The gate system of claim 1, wherein the frame assembly includes a pair of vertical posts spaced from each other, each of the posts containing one of the actuators.

4. The gate system of claim 1, wherein the door includes a first door panel and a second door panel each rotatable independently from each other about a vertical axis extending through the frame assembly.

5. The gate system of claim 4, wherein each of the door panels is independently rotatable from each other about the axis extending horizontally through the frame assembly.

6. The gate assembly of claim 2, wherein the guide rails are each formed from a dog-legged shaped track arm cooperating with a surface of the tracking assembly.

7. A method for operating a gate in a manual mode by a user, said method comprising:
initiating the manual mode to manually open or close the gate;
determining that the user has pressed a gate close input button;
closing the gate in response to the gate close input button being pressed;
periodically determining whether the gate has reached a fully closed position;
determining whether the gate close input button is still being pressed if the gate has not reached the fully closed position; and
stopping closing the gate if the gate close input button is not being pressed or the gate has reached the fully closed position.

8. The method for operating a gate in a manual mode by a user of claim 7, wherein the method further comprises:
determining that the user has initiated an input signal by pressing a gate open input button;
opening the gate in response to the input signal initiated by the gate open input button being pressed;
periodically determining whether the gate has reached a fully open position;
determining whether the gate open input signal is still being pressed if the gate has not reached the fully open position; and
stopping opening the gate if the gate open input button is not being pressed or the gate has reached the fully open position.

9. The method for operating a gate in a manual mode by a user of claim 8, wherein a human-machine interface comprises the gate close input button and the gate open input button, the human machine interface being operatively connected to a programmable logic controller via an Ethernet connection.

10. A fail-safe programmable logic controller (PLC) circuit for controlling a gate, said PLC circuit comprising:
a PLC including a first input terminal and a second input terminal;
a light curtain switch electrically coupled to the first and second input terminals, said light curtain switch configured to be responsive to a signal from an optical light curtain device that is configured to detect an object in a light curtain, wherein the light curtain switch transmits a stop signal to stop movement of the gate in response to the signal from the optical light curtain device;
a bump strip switch electrically coupled to the first and second input terminals, said bump strip switch being responsive to a signal from a bump strip on the gate that indicates that the gate has hit something to stop movement of the gate; and
a laser camera switch electrically coupled to the first and second input terminals, said laser camera switch being responsive to a signal from a laser camera that indicates that an item is in a travel area of the gate to stop movement of the gate.

11. The fail-safe PLC circuit for controlling a gate of claim 10, wherein the light curtain device comprises self-monitoring circuitry, a transmitter, and a receiver, wherein the transmitter is aligned with the receiver and comprises one or more light emitting component configured to send a plurality of light pulses to the receiver according to a frequency pattern thereby forming the light curtain.

12. The fail-safe PLC circuit for controlling a gate of claim 10, wherein the stop signal is transmitted to at least one of the first input terminal and the second input terminal.

13. The fail-safe PLC circuit for controlling a gate of claim 12, wherein the stop signal is transmitted to both the first input terminal and the second input terminal.

14. The fail-safe PLC circuit for controlling a gate of claim 10, wherein the signal from the optical light curtain device is configured to be triggered based detecting the object in the light curtain and is further configured to close the light curtain switch thereby stopping movement of the gate.

15. The fail-safe PLC circuit for controlling a gate of claim 10, wherein the bump strip is positioned on a bottom edge of the gate.

16. The fail-safe PLC circuit for controlling a gate of claim 10, wherein the PLC circuit further comprises one or more additional safety devices to determine if two cars are tailgating.

17. The fail-safe PLC circuit for controlling a gate of claim 10, wherein the PLC circuit further comprises a sensor configured to detect whether an over-height vehicle is detected.

18. The fail-safe PLC circuit for controlling a gate of claim 10, the PLC circuit further comprising a down pressure switch, an up-pressure switch, and an emergency stop switch.

19. The fail-safe PLC circuit for controlling a gate of claim 10, wherein the PLC further includes an output terminal configured to transmit a safety signal to a motor configured to control movement of the gate.

20. The fail-safe PLC circuit for controlling a gate of claim 19, wherein the motor includes either a close motor to close the gate or an open motor to open the gate.
